(19) United States
(12) Patent Application Publication
(10) Pub. No.: US 2004/0204515 A1
(43) Pub. Date: Oct. 14, 2004

(54) Chemical resistant epoxy composition

(76) Inventors: Edita Rojasova, Cupertino, CA (US); Rong Jong Chang, Fremont, CA (US); Linas Mazeika, San Carlos, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/758,944

(22) Filed: Jan. 16, 2004

Related U.S. Application Data
(60) Provisional application No. 60/441,075, filed on Jan. 17, 2003.

(51) Int. Cl. C08L 63/00

(52) U.S. Cl. 523/466; 523/400

(57) ABSTRACT

The present invention provides a chemical resistant epoxy composition comprising epoxy resin of 100 parts by weight and precipitated silica of 5-65 parts. We have discovered that the addition of precipitated silica surprisingly improves the chemical resistance property of the epoxy composition substantially. The chemical resistant epoxy composition is highly resistant to chemical attack and can be advantageously used for short or long term direct, total, continuous, or intermittent immersion applications, such as interior and exterior protective coatings, adhesives, encapsulants, or resin-fiber composites.

### FIELD OF THE INVENTION

This invention is related generally to a liquid epoxy composition useful for protective coatings, encapsulants, adhesives, and composites. More particularly, it relates to a liquid epoxy composition that is highly resistant to chemical attack.

### DESCRIPTION OF THE BACKGROUND ART

Epoxy resin is one of the most widely used coatings for protecting steel due to its versatility and generally good chemical, corrosion resistance. Epoxy coatings can be formulated with a wide variety of starting resins such as Bisphenol A, Bisphenol F, Novolac Epoxy, and Phenolic epoxy as well as a wide selection of curing agents such as polyamide amines, aliphatic amines, cycloaliphatic amines, aromatic amines and anhydrides. Also, epoxy coatings are available in liquid as well as in powder forms. An excellent summary of using epoxy protective coatings can be found in “Corrosion Prevention by Protective Coatings, Chapter 5, Second Edition,” by Charles Munger (NACE Publications).

The chemical resistance of a polymeric composition, including coating, encapsulant and adhesive, is affected potentially by all ingredients in the mixture. However, since the resin binder is mostly the continuous phase, it exerts a primary influence on the chemical resistance of the entire formulation. Those who skilled in the art will have no problem in selecting a proper resin and curing agent (together they constitute the binder) to improve chemical resistance of epoxy coating to achieve an ordinary degree of chemical resistance. For example, the chemical resistance of epoxy coatings is generally acceptable when the coatings are only exposed to ambient conditions such as coating of bridges, buildings, the exterior of a pipe or the exterior of a storage tank, and there are wide spread use of epoxy coatings for such applications. Even for short-term exposure to harsher environments, such as a concrete protective coating for secondary containment, a commonly formulated epoxy based on known arts often functions satisfactorily. A technical bulletin published by Air Products titled “Chemical Resistance for Ambient Cure Epoxy Formulation,” gives a general guideline on how to select an epoxy resin type and a curing agent to improve chemical resistance.

However, if an epoxy coating is used for long term direct immersion service, such as coating of the interior of tanks, vessels, piping and other containers, it requires an extraordinary chemical resistance since the coating is under total, continuous or intermittent immersion of the liquid(s) under storage or transport. The coating must resist swelling or chemical attack of the liquid so that it will not only serve as an effective barrier to protect the storage vessels but also to maintain purity of the stored liquid. Moreover, the same storage vessel is often used to store different chemicals and the changeover to a new chemical requires solvent washing and cleaning of the previous stored chemical with a solvent. Thus, the same coating on a storage vessel must resist to a wide variety of chemicals, including acids, alkalis, organic solvents, oxidizing agents, fats and oils, etc. The problem is further exacerbated if the storage vessel is for strong acids such as 98% sulfuric acid, or strong base such as 70% hydroxide.

Some specially formulated epoxy coatings such as a phenolic epoxy bake coating has been used in the direct immersion applications as described in Chapter 11 of “Coatings and Linings for Immersion Service, Revised Edition,” published by NACE (National Association of Corrosion Engineers). Although a phenolic epoxy can resist a wide variety of chemicals including low concentration inorganic acid such as 20% hydrochloric acid or 10% sulfuric acid, it is not recommended for higher concentration acids such as 35% hydrochloric acid or 98% sulfuric acid.

In addition to the binder, fillers are often present in a coating with the highest volume percentage. For a less critical application such as house paint, fillers are often added to reduce cost. For most industrial coatings, one must select fillers very carefully as many fillers deteriorate chemical resistance as they may react with acids or alkalis. For example, calcium carbonate has a very poor resistance to acids.

Silica is often used as a filler in many polymer compositions including coatings. Silica is a term used to represent various forms of silicon dioxide, including amorphous silicas such as fumed silica, fused silica and precipitated silica; semicrystalline silicas such as diatomaceous earth; vitreous silicas which are supercooled glasses; and crystalline silicas such as quartz. Colloidal silicas are suspension of amorphous silica in water or alcohol.

In the coating industry, fumed silica is widely used as a thixotropic agent which imparts high viscosity at low shear rates to prevent sagging after the coating is applied onto a substrate, but does not significantly increase the viscosity at high shear rates to the extent that will hinder the coating application such as spraying or brushing. Silica sands which are mostly crystalline silica are often used to increase skid resistance of concrete floor coatings.

In the rubber industry, fumed silicas are most often used to reinforce silicone rubber as described in the published paper titled “Interactions and Chemical Reactions of Polydimethylsiloxanes with Fumed Silica Fillers,” by H. Barthel et al, presented in the Rubber Division (American Chemical Society) meeting, Oct. 16-19, 2001, Cleveland, Ohio. Precipitated silicas are most often used for reinforcement of tire rubbers as described in two papers published in Rubber Chemistry and Technology, Vol. 75 (2002), pp527-547 and pp 563-579.

In the plastics industry, a paper by Petti presented at the 7^{th} International SAMPE Electronics Conference, Jun. 20-23, 1994, suggested the use of fused silica to improve rheological and moisture absorption properties of epoxy molding compounds.

To date, however, no one has specifically used or taught the use of silica to improve chemical resistance of an epoxy composition.

In U.S. Pat. Nos. 5,026,816 and 5,169,912, Keehan discloses that acid resistance of an epoxy can be improved by chemically linking an epoxy resin and an oxide such as fused silica by imidazole. Keehan also discloses in U.S. Pat. Nos. 5,658,996 and 6,180,723 that further improvement can be made by incorporating a monomer or oligomer which contains multiple functional p-hydroxylphenyl groups such as tris(p-hydroxy-phenyl)methane or poly(p-hydroxylstyrene). These prior patents, however, do not teach specifically that the addition of silica without deliberate chemical linkage to epoxy resin can indeed improve chemical resistance of an epoxy coating.

In U.S. Pat. No. 4,499,217, Yoshimura et al. disclose that the addition of colloidal silica as alcohol solution improves solvent resistance of a whole list of thermoset resins including epoxy. Although the use the colloidal silica is disclosed, there is no mention of improvement of acid resistance.

In U.S. Pat. No. 4,383,060, Dearlove et al. disclose an epoxy adhesive composition containing “natural silica,” which is presumably silica sand and colloidal silica, and an imidazole curing agent for improved adhesion to SMC (sheet molding compounds) at 200° C., salt spray, humidity and water soak. In U.S. Pat. No. 4,849,297, Mansell et al. disclose the use of precipitated silica containing 6 to 9% calcium oxide as corrosion inhibiting filler in various resins, including epoxy. However, neither of these two patents discloses an improvement in chemical resistance.

Clearly, there is still a need for an epoxy coating that can resist higher concentration inorganic acids while maintaining good resistance to other chemicals. Even some formulations that claimed to be able to resist 98% sulfuric acid are based on short-term exposure tests, and often fail in long-term immersion. Therefore, a new epoxy composition with superior chemical resistance especially in long-term immersion applications would be highly desirable and would fulfill the void of what existing products offer.

### SUMMARY OF THE INVENTION

We have discovered that the addition of precipitated silica surprisingly improves chemical resistance significantly. The present invention provides a chemical resistant epoxy composition comprising epoxy resin of 100 parts by weight and precipitated silica of 5-65 parts. The chemical resistant epoxy composition is highly resistant to chemical attack and can be advantageously used for short or long term direct, total, continuous, or intermittent immersion services or applications, such as interior and exterior protective coatings, adhesives, encapsulants, or resin-fiber composites.

### BRIEF DESCRIPTION OF THE DRAWINGS

FIG. 1 is a chart showing a comparison between Example 1, which is formulated in accordance with the present invention, and Comparative Example 1, which is one of the most chemical resistant epoxy known in the art, in a high temperature curing epoxy system.

FIG. 2 is a chart showing a comparison between Example 2 and Comparative Example 2 in a lower temperature cure system.

FIG. 3 compares the low bake epoxy with a commercial product.

FIG. 4 compares the chemical resistance of Example 1 with a commercial product.

### DESCRIPTION OF INVENTION

The present invention provides a chemical resistant epoxy composition comprising epoxy resin of 100 parts by weight and precipitated silica of 5-65 parts. We have discovered an unexpected result of adding precipitated silica. That is, the resulting epoxy composition has a substantially improved chemical resistance. The chemical resistant epoxy composition disclosed herein is highly resistant to chemical attack and can be advantageously used for short or long term direct, total, continuous, or intermittent immersion service, such as interior and exterior protective coatings, adhesives, encapsulants, or resin-fiber composites. We shall describe our invention by way of examples and comparative examples.

In the following Example 1 and Comparative Example 1, the effect of precipitated silica on the chemical resistance is demonstrated in a high temperature curing epoxy system. Comparative Example 1 is a novolac epoxy cured by an aromatic amine(Aradur 976-1 or diaminodiphenylsulfone), which is one of the most chemical resistant epoxy taught in the prior art. The Example 1 is formulated according to the present invention.

### EXAMPLE 1

| | Ingredient | Description | Parts by Weight |
|---|---|---|---|
| 1-1 | Epalloy 8230 | Novolac Epoxy | 100 |
| | | (CVC-Specialty Chemicals) | |
| 1-2 | Hi-Sil 233 | Precipitated Silica | 28 |
| | | (PPG-Industries, Inc.) | |
| 1-3 | Red Iron Oxide | Pigment (Fisher Scientific) | 0.7 |
| 1-4 | Aradur 976-1 | Curing Agent (Vantico, Inc.) | 36.5 |
| | | Total | 165.2 |

### COMPARATIVE EXAMPLE 1

| | Ingredient | Description | Parts by Weight |
|---|---|---|---|
| C1-1 | Epalloy 8230 | Novolac Epoxy (CVC-Specialty Chemicals) | 100 |
| C1-2 | Red Iron Oxide | Pigment (Fisher Scientific) | 0.7 |
| C1-3 | Aradur 976-1 | Curing Agent (Vantico, Inc.) | 36.5 |
| | | Total | 136.5 |

Example 1 and Comparative Example 1 were both prepared by mixing the ingredients in a high-speed disperser at 2000 rpm at ambient temperature. Hi-Sil 233 was previously pre-dried in the oven at 110° C. for 2 hours to remove physically and chemically bonded water on the silica surface. Fifteen individual samples of Example 1 composition and Comparative Example 1 composition were prepared by pouring the mixture of ingredients into round aluminum dishes with 2.3 inch in diameter. Samples were casted 0.05 inch thick.

All samples were baked in the air-circulated oven at 175° C. for 4 hours followed by 24 hours at 120° C. Chemical resistance test of the resulting samples was conducted according to ASTM D543 chemical immersion test at 23° C. for 1 week. List of chemicals used for the test includes: sulfuric acid (H₂SO₄) at 98%, 76%, 50%, 35% and 10% concentration, 1 N hydrochloric acid (HCI), water, 30% sodium chloride (NaCl) water solution, saturated 50% water solution of sodium hydroxide (NaOH), mineral oil, acetone, ethanol, xylene, methyl-ethyl ketone (MEK) and Toluene. The set of samples from Example 1 was compared side by side with the set of samples from Comparative Example 1.

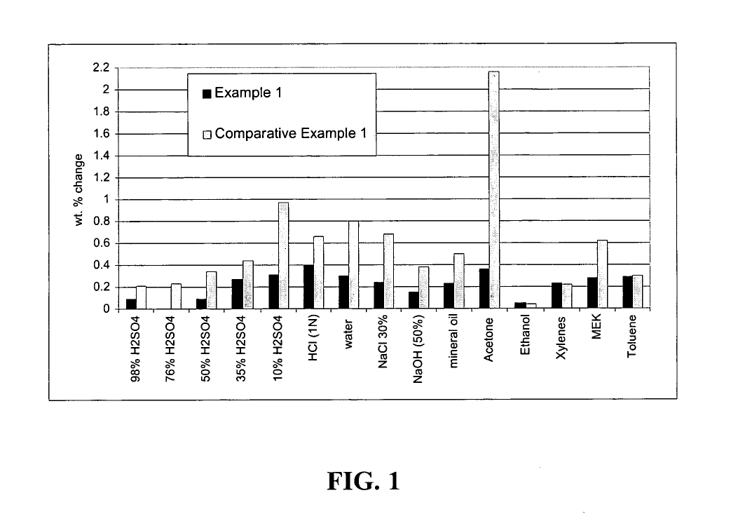

Comparison was made on the base of sample weight change in % after immersion in each individual chemical. The lower percentage of weight change after immersion in a chemical represents the better the resistance of the composition to that chemical. Graphical presentation of this comparison is given in the FIG. 1, which clearly shows that Example 1, with the addition of Hi-Sil 233, significantly surpassed the Comparative Example 1 in the majority of chemicals tested.

In the following Example 2 and Comparative Example 2, the effect of precipitated silica on the chemical resistance is demonstrated in a lower temperature curing epoxy system using the same curing agent MXDA (meta-xylenediamine).

### EXAMPLE 2

| | Ingredient | Description | Parts by Weight |
|---|---|---|---|
| 2-1 | Epalloy 8230 | Novolac Epoxy | 100 |
| | | (CVC-Specialty Chemicals) | |
| 2-2 | Hi-Sil 233 | Precipitated Silica | 28 |
| | | (PPG-Industries, Inc.) | |
| 2-3 | MXDA | Curing agent | 20.02 |
| | | (Mitsubishi Gas Chemical) | |
| | | Total | 148.02 |

### COMPARATIVE EXAMPLE 2

| | Ingredient | Description | Parts by Weight |
|---|---|---|---|
| C2-1 | Epalloy 8230 | Novolac Epoxy | 100 |
| | | (CVC-Specialty Chemicals) | |
| C2-2 | MXDA | Curing agent | 20.02 |
| | | (Mitsubishi Gas Chemical) | |
| | | Total | 120.02 |

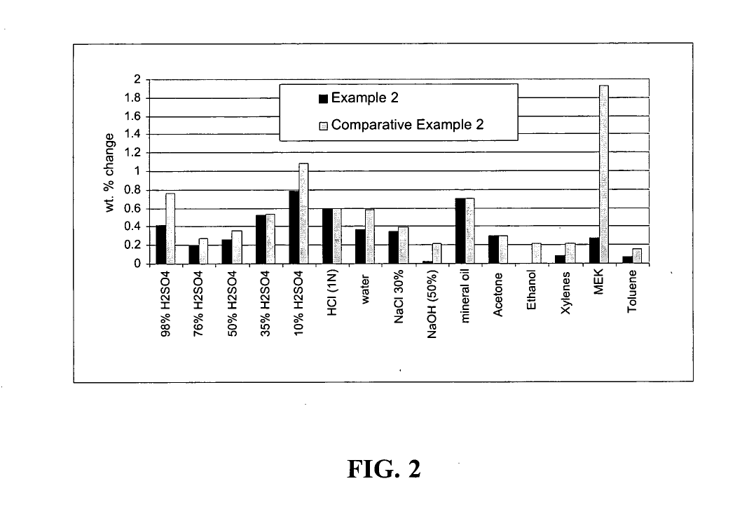

Example 2 and Comparative Example 2 were both prepared by mixing the ingredients in a high-speed disperser at ambient temperature. Hi-Sil 233 was pre-dried as stated in Example 1. Fifteen individual samples of Example 2 composition and 15 individual samples of Comparative Example 2 were prepared by pouring the mixture of ingredients into round aluminum dishes with 2.3 inch in diameter. Samples were cast 0.05 inch thick. All samples were baked in the air-circulated oven at 94° C. for 6 hours. Chemical resistance test of the resulting samples was conducted according to ASTM D543 at 23° C. for 1 week. To same chemicals as listed in Example 1 were used for testing. The set of samples from Example 2 was compared side by side with the set of samples from Comparative Example 2. Comparison was made on the base of sample weight change in % after immersion in each individual chemical. Graphical presentation of this comparison is given in the FIG. 2. Again, it is clearly shown that Example 2, with the addition of Hi-Sil 233 according to the present invention, significantly surpassed the Comparative Example 1 in the majority of chemicals tested.

A comparison was also made between an optimized lower cure formulation, as shown in the Example 3 according to the present invention, and a commercially available premium chemical resistant epoxy coating, Chemline™ 784/32 (A product of Advanced Polymer Coatings).

### EXAMPLE 3

| | Ingredient | Description | Parts by Weight |
|---|---|---|---|
| 3-1 | Epalloy 8240 | Novolac Epoxy | 100 |
| | | (CVC-Specialty Chemicals) | |
| 3-2 | Hi-Sil 233 | Precipitated Silica | 25 |
| | | (PPG-Industries, Inc.) | |
| 3-3 | Red Iron Oxide | Pigment | 0.9 |
| | | (Fisher Scientific) | |
| 3-4 | RCF-015A | Glass flake | 60 |
| | | (NGF Canada Ltd.) | |
| 3-5 | MXDA | Curing agent | 20.02 |
| | | (Mitsubishi Gas Chemical) | |
| | | Total | 205.92 |

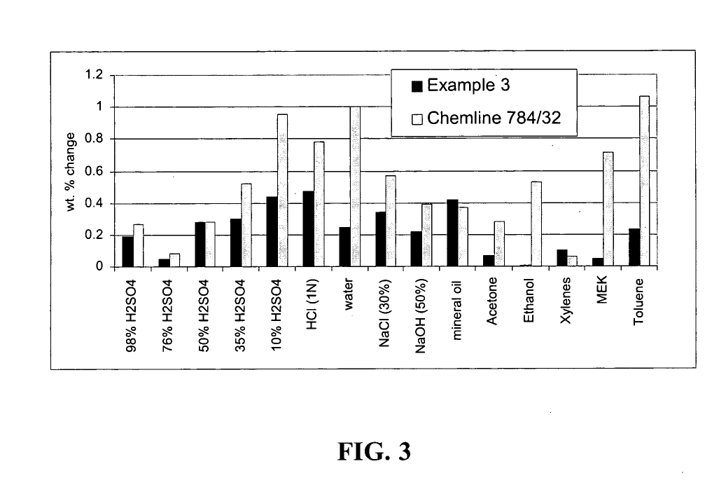

A set of samples for Example 3 was prepared by mixing the ingredients in high-speed disperser at ambient temperature. Hi-Sil 233 was pre-dried as stated in Example 1. Fifteen individual samples of Example 3 were prepared by pouring the mixture of ingredients into round aluminum dishes with 2.3 inch in diameter. Samples were cast 0.05 inch thick. Samples were baked in the air-circulated oven at 94° C. for 6 hours. Chemical resistance of Example 3 composition was compared with chemical resistance of commercial product Chemline™ 784/32 on the same weight change basis and at conditions described in previous examples. Chemline™ 784/32, a product of Advanced Polymer Coatings, represents currently the top of chemical resistant industrial coatings available on the market. Its manufacturer reports coating to resist wide range of the harshest chemicals used in long-term direct immersion service. Fifteen individual samples of Chemline™ 784/32 were prepared and cured following manufacturer's instructions and cured at the same (manufacturer's given) cure schedule as Example 3. A set of samples from Example 3 was compared side by side with the set of Chemline™ 784/32 samples. Graphical presentation of this comparison is given in the FIG. 3. Once again, the results showed that Example 3 according to the present invention outperformed the premium commercial product in all chemicals except acetone and mineral oil.

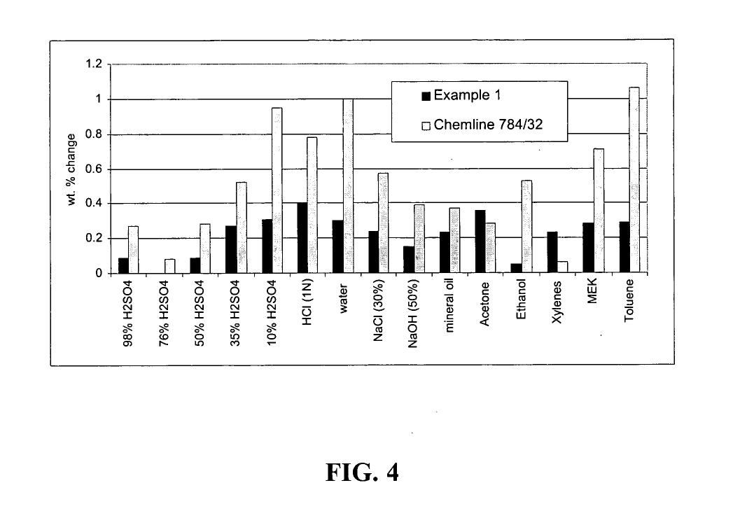

A chemical resistance comparison was also made between Example 1 described previously and Chemline™ 784/32. Graphical presentation of this comparison is given in the FIG. 4.

By the examples given above, one skilled in the art will appreciate that the present invention advances the state of art beyond the teachings of what have been published in the open literature as well as what the best of the currently available commercial products can offer.

Although the present invention and its advantages have been described in detail, it should be understood that the present invention is not limited to or defined by what is shown or discussed herein; rather, the invention may be practiced with certain specific details herein omitted or altered. The drawings, description and discussion herein illustrate technologies related to the invention, show examples of the invention and provide examples of using the invention. Known methods, procedures, systems, circuits or components may be discussed or illustrated without giving details, so to avoid obscuring the principles of the invention. One skilled in the art will realize that implementations of the present invention could be made without departing from the principles, spirit or legal scope of the present invention. Accordingly, the scope of the present invention should be determined by the following claims and their legal equivalents.

We claim:

1. A chemical resistant epoxy composition useful for short or long term direct, total, continuous, or intermittent immersion applications, said chemical resistant epoxy composition comprising:
epoxy resin of 100 parts by weight; and
precipitated silica of 5-65 parts.

2. The chemical resistant epoxy composition according to claim 1, in which said precipitated silica is pre-dried.

3. The chemical resistant epoxy composition according to claim 1 utilized in protective coatings.

4. The chemical resistant epoxy composition according to claim 1 utilized in adhesives.

5. The chemical resistant epoxy composition according to claim 1 utilized in encapsulants.

6. The chemical resistant epoxy composition according to claim 1 utilized in resin-fiber composites.
